(19) United States
(12) Patent Application Publication
(10) Pub. No.: US 2021/0092974 A1
(43) Pub. Date: Apr. 1, 2021

(54) DEVICE FOR TEMPERING EDIBLE PRODUCTS

(71) Applicant: KW Patente AG, Mustair (CH)

(72) Inventor: Guido Knobel, Slaenstein (CH)

(21) Appl. No.: 17/036,350

(22) Filed: Sep. 29, 2020

(30) Foreign Application Priority Data
Sep. 30, 2019 (DE) 10 2019 126 354.9
Dec. 18, 2019 (DE) 10 2019 134 989.3

(51) Int. Cl. A23G 1/18

(52) U.S. Cl. CPC A23G 1/18

(57) ABSTRACT

In a device for tempering edible products, in particular chocolate articles, in at least one mould (6) before and/or after the edible products is filled into this mould (6), wherein trays (5) for the moulds (6) are provided on a wall (4), slots (11.1, 11.2; 13.1, 13.2) are provided in the wall (4) above and below the mould to allow a tempering medium to escape.

### BACKGROUND OF THE INVENTION

The invention relates to a device for tempering edible products, in particular chocolate articles, in at least one mould before and/or after the edible products is filled into this mould, wherein trays for the moulds are provided on a wall.

From the DE 10 2018 103 736.8 a device of the type mentioned above is known in which individual, separate trays are provided for the moulds in a processing station. These moulds are handled by a robot. The trays only make contact with the moulds at points or in lines.

### SUMMARY OF THE INVENTION

The object of the present invention is to improve the above-mentioned device, in particular with regard to the required hygiene and at the same time to optimize the treatment with the tempering medium.

The solution to the object is to provide slots in the wall above and below the mould to allow a tempering medium to escape.

The arrangement of the slots above and below the mould causes a specific application of the tempering medium to the mould. The shape and the arrangement of the slots play a very important role in the present invention, as will be described later.

The trays should be designed as profiles. They can be made of any material, but of course an easy-care material such as stainless steel is preferred. If a metal is used to produce the trays, it is advisable to fold a corresponding metal strip as desired. In a preferred embodiment, the profile should have a channel section from which an edge strip protrudes at each side, on which the mould rests, and which is open towards the wall. This means that the mould is only supported by the edge strips, so that its essential parts remain accessible to the tempering medium. A laterally closed space, open only to the front, is formed under the mould, into which the lower and upper slots, which are moulded into the wall, open out. This in turn means that the tempering medium is trapped to a certain extent in this space below the mould and thus intensively washes the bottom and the top of the mould. If a cooling tempering medium is used, it does not sink down immediately, but is pressed upwards against the bottom of the mould. There it can develop its cooling effect to a sufficient extent. The space under the mould can also be open.

The preferred and essential feature of the present invention is that a lower edge of the lower slot lies in the level of a channel bottom. This means, for example, that a cleaning agent is used to clean the entire profile and in particular the bottom of the profile can flow backwards through the wall and does not remain in a transition area between the wall and the profile, which generally protrudes at right angles from the wall. This enables complete and intensive cleaning of the profile.

A Z-shaped rail profile is preferably connected to at least one lateral edge strip of the channel section. This rail profile limits the mould's range of movement so that the mould is held on the tray in a desired, predetermined arrangement.

The upper slots should preferably extend essentially across the width of the mould. If a cooling tempering medium is used, it falls out of the upper slots onto the mould in a regular distribution due to the width of these slots, so that the cooling of the mould is even.

In a preferred embodiment of the invention, the lower slots shall have a smaller width than the upper slots. This means that less tempering medium escapes from the lower slots than from the upper slots. This takes into account the fact that the tempering medium from the lower slots below the mould is trapped in the space formed by the profile and the mould, while the tempering medium from the upper slots flows freely over the mould. For this reason, more tempering medium is required above the mould than below the mould to uniform the tempering of the mould. The upper and lower slots can also be the same size.

The invention provides, as mentioned above, that the trays butt against the wall and protrude from the wall at an angle of approximately 90°, whereby a gap between the tray and the wall is closed. If a metallic profile strip is used as a tray, it is advisable to weld it directly to the wall, whereby the weld seam can be designed in such a way that dirt or cleaning agents do not accumulate in the area between the tray and the wall. For example, the weld seam can be bevelled from the wall towards the profile.

In one embodiment, the wall can be part of a closed wall box into which the tempering medium can be introduced. This means that the tempering medium in the wall box, which is closed, is under slight pressure and thus also emerges from the slots under low pressure. Since the width of the upper slots is greater than the width of the lower slots, the exit of the tempering medium from the upper slots is slower than from the lower slots. This means that the tempering medium falls more smoothly from the upper slots onto the mould, while the bottom of the mould is flushed more intensively with the tempering medium from the lower slots. For this purpose, it could also be provided that the lower slots are oriented more upwards towards the mould bottom, for which purpose additional guide elements could be arranged. The upper and the lower slots could also be the same size.

Due to the overpressure in the wall box and the correct dimensioning of the outlet slots and maintenance of a small overpressure ensures an almost even outflow of the air through the slots without air baffles. The wall box is completely hollow without air baffles. For this reason, it is easier to clean, which considerably improves hygiene.

There are many conceivable ways of introducing the tempering medium into the wall box and these are covered by the present invention. In a preferred embodiment it is intended that at least one suction fan is assigned to the wall box. This suction fan sucks in a tempering medium and presses it into the wall box.

### BRIEF DESCRIPTION OF THE DRAWINGS

Further advantages, features and details of the invention result from the following description of preferred embodiment and from the drawing; these show in

FIG. 1 a perspective front view of a device for tempering edible products in accordance with the invention;

FIG. 2 a section from a direct front view of the device according to FIG. 1.

### DETAILED DESCRIPTION

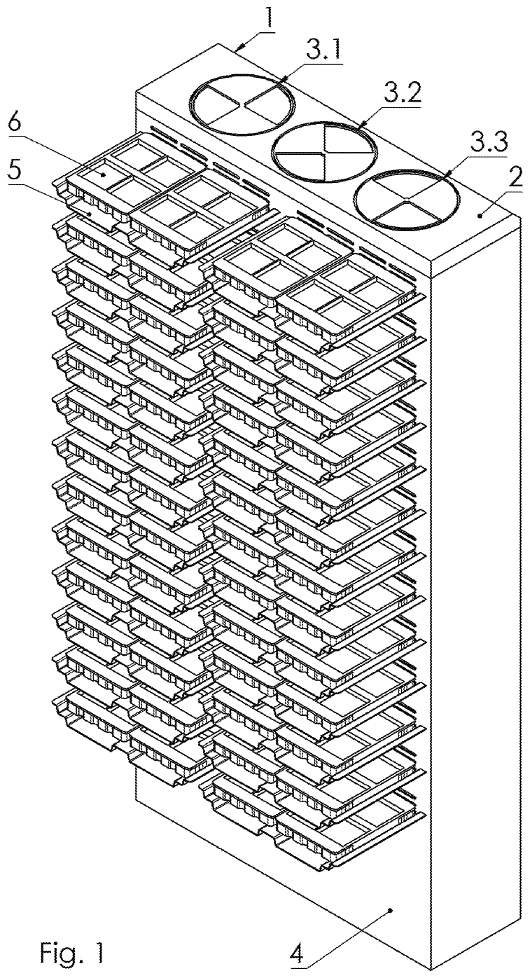

According to FIG. 1, a device for tempering edible products according to the invention has a wall box 1, which is shown as a rectangular cube in this exemplary embodiment. Inside, the wall box 1 is hollow and overall essentially closed.

Three fans 3.1, 3.2 and 3.3 are integrated in an upper cover 2. These can be suction fans, for example, which suck in a tempering medium and press it into the wall box 1. Of course, the tempering medium can also be filled into the wall box 1 in another way. For example, more or less fans can also be integrated.

The wall box 1 has a wall 4 on which a number of trays 5 are arranged. In the position of use, these trays 5 support moulds 6 to be treated.

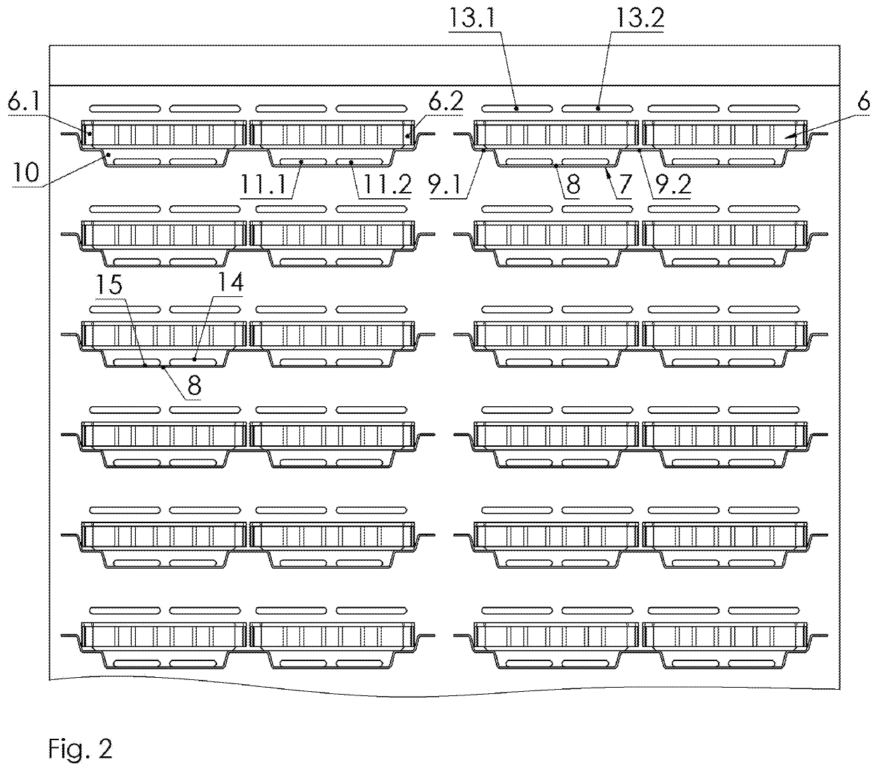

In FIG. 2 the trays 5 are more visible. In the embodiment shown, the tray 5 is used to carry two adjacent moulds 6.1 and 6.2. Of course, the tray could also carry only one mould or several moulds.

Each tray 5 consists of a profile that is folded in the desired manner. In the embodiment, a channel section 7 is formed with a channel bottom 8 and at least one edge strip 9. The mould 6 rests on the edge strip 9, so that a space 10 open to the front is formed by the edge strips 9.1 and 9.2, the channel bottom 8 and the mould 6. Two lower slots 11.1 and 11.2, which have a width b1, open out into this space 10.

A Z-shaped rail profile 12 is attached to the side of the edge strip 9.1, which serves as the lateral boundary of the mould 6.

Above the mould 6, two upper slots 13.1 and 13.2 are provided, which in turn have a width b2 which is greater than the width b1.

The functioning of the present invention is as follows:

For tempering, the moulds 6 are placed on the trays 5 either manually or with a handling device. The fans 3.1-3.3 then suck in air as the tempering medium and press it into the wall box 1. This tempering medium exits from the lower slots 11.1 and 11.2 as well as from the upper slots 13.1 and 13.2. The tempering medium emerging from the upper slots 13.1 and 13.2 falls onto the surface of the mould 6 and is distributed evenly for tempering. This is also supported by the greater width b1 of the upper slots 13.1 and 13.2, which extend almost over the entire width of the mould.

The tempering medium from the lower slots 11.1 and 11.2 enters the space 10, which is only open to the front, and is thus trapped to a certain extent in this space 10, so that it is pressed upwards against the bottom of the mould 6. This supports the tempering process there. By choosing a smaller width b1 of the lower slots 11.1 and 11.2 compared to the width b2 of the upper slots 13.1 and 13.2, the tempering medium exits slightly accelerated into the space 10, so that it flows evenly from below against the bottom of the mould 6. This also contributes to the uniformity of the tempering of the mould. As a rule, this involves cooling.

It can also be seen that a lower edge 14 of the lower slots 11.1 or 11.2 lies in one level with a surface 15 of the channel bottom 8. This means that dirt or cleaning agents cannot remain in the area of the channel section 7 where it strikes against the wall 4, but instead flow backwards through the lower slots 11.1 or 11.2. This considerably improves the cleaning ability of the trays 5.

Reference symbol list

| | | |
|---|---|---|
| 1 | Wandkasten | wall box |
| 2 | Abdeckung | cover |
| 3 | Ventilator | fan |
| 4 | Wand | wall |
| 5 | Ablage | tray |
| 6 | Form | mould |
| 7 | Kanalteil | channel section |
| 8 | Kanalboden | channel bottom |
| 9 | Randstreifen | edge strip |
| 10 | Raum | space |
| 11 | untere Schlitz | lower slot |
| 12 | Schienenprofil | rail profile |
| 13 | oberer Schlitz | upper slot |
| 14 | unterer Rand | lower edge |
| 15 | Oberfläche | surface |

1. Device for tempering edible products, in particular chocolate articles, in at least one mould (6) before and/or after the edible products is filled into this mould (6), wherein trays (5) for the moulds (6) are provided on a wall (4), wherein slots (11.1, 11.2; 13.1, 13.2) are provided in the wall (4) above and below the mould to allow a tempering medium to escape.

2. Device according to claim 1, wherein the trays (5) are designed as profiles.

3. Device according to claim 2, wherein the tray (5) has a channel section (7) from which an edge strip (9.1, 9.2) protrudes laterally in each case, on which the mould (6) rests and which is open towards the wall (4).

4. Device according to claim 3, wherein lower slots (11.1, 11.2) are provided at the height of the channel section (7) below the mould (6).

5. Device according to claim 4, wherein a lower edge (14) of the lower slot (11.1, 11.2) lies in the level of a channel bottom (8).

6. Device according to claim 3, wherein a Z-shaped rail profile (12) is connected to at least one lateral edge strip (9.1) of the channel section (7).

7. Device according to claim 1, wherein the upper slots (13.1, 13.2) extend essentially over the width of the mould (6).

8. Device according to claim 1, wherein the trays (5) butt against the wall (4) and protrude therefrom at an angle of approximately 90°, whereby a gap between the tray (5) and the wall (4) is closed.

9. Device according to claim 1, wherein the wall (4) is part of a closed wall box (1) into which the tempering medium can be introduced.

10. Device according to claim 9, wherein at least one suction fan (3.1-3.3) is assigned with the wall box (1).
